(19) United States
(12) Patent Application Publication
(10) Pub. No.: US 2010/0238918 A1
(43) Pub. Date: Sep. 23, 2010

(54) Method and Device for Transmitting Data Using DSL Technology

(76) Inventors: Dieter Gleis, Grosskarolinenfeld (DE); Pidder Kassel, Oberhaching (DE); Mathias Riess, Muenchen (DE)

Correspondence Address: SLATER & MATSIL, L.L.P., 17950 PRESTON ROAD, SUITE 1000, DALLAS, TX, 75252, US

(21) Appl. No.: 11/813,988

(22) PCT Filed: Dec. 23, 2005
(86) PCT No.: PCT/EP2005/014014

§ 371 Date: Mar. 10, 2008

(30) Foreign Application Priority Data
Jan. 14, 2005 (DE) 10 2005 001 956.0

(51) Int. Cl. H04L 12/66

(52) U.S. Cl. 370/352

(57) ABSTRACT

The invention relates to a method and a device for transmitting data, wherein when transmitting data with DSL technology transmission rates are compared.

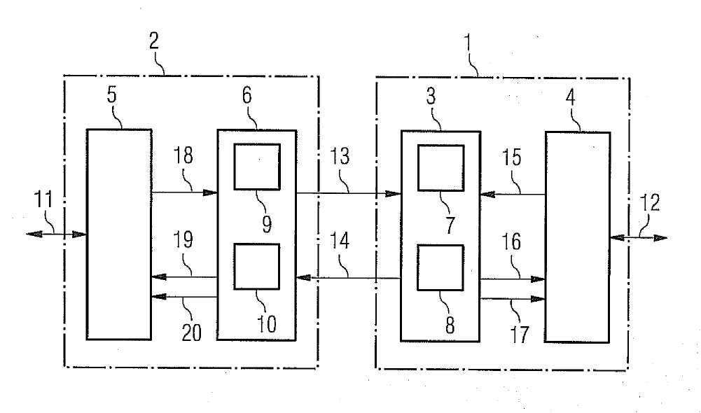

This application is a national phase filing of PCT/EP2005/014014, filed Dec. 23, 2005, which application claims priority to German Patent Application No. 10 2005 001 956.0, filed Jan. 14, 2005, both of which applications are incorporated herein in their entirety by reference.

### TECHNICAL FIELD

The present invention relates to a method and a device for transmitting data using DSL technology, whereby in particular a loss of data is almost impossible.

### BACKGROUND

Due to the increasing number of internet users and due to the increasing amounts of data that are moved uplink or downlink by a user of the internet, DSL technologies for transmitting data are becoming increasingly popular particularly on the so-called last or first mile (EFM=Ethernet in the First Mile) on the connection path to the internet user. Therefore transmitting data by means of DSL technology should be as secure as possible and not tolerate any loss of data packets. If for example the data are sent at a data rate that is higher than a rate at which a receiving unit that receives this data can process this data, a loss of data can occur.

### SUMMARY OF THE INVENTION

According to the invention, data are transmitted between a first and a second device by means of DSL technology, wherein transmission rates are compared. This helps to prevent a loss of data during a transmission of data between the first and the second device.

### BRIEF DESCRIPTION OF THE DRAWINGS

The present invention is explained further below with reference to the attached drawings on the basis of preferred embodiments.

The sole FIGURE shows two devices according to the invention which achieve the transmitting of data by means of DSL technology.

### DETAILED DESCRIPTION OF ILLUSTRATIVE EMBODIMENTS

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and is not intended to be limited by the exemplary embodiments described hereinafter.

According to an embodiment of the invention, a method for transmitting data is provided in which data are transmitted between a first and a second device by means of DSL technology. During this transmitting of data, a comparison of transmission rates takes place. In particular, both the first and also the second device are each provided with a unit that operates at the first layer of the OSI layer model. With this, the transmitting of data between these two units takes place using DSL technology. Furthermore, the first device is preferably located in an end-node of a communication network and the second device is located in an intermediate node of the communication network.

The end-node of the communication network is a node of the communication network that is assigned to a specific end-user and within the communication network has only one connection to an intermediate node, i.e. there is a connection in the communication network to the end-node only via this intermediate node. Transmission rate comparison, or rather user data transmission rate comparison, is understood as meaning that the first (second) device sends user data to the second (first) device only at a transmission rate at which the second (first) device can then also process this user data. This prevents a loss of data from occurring as the first (second) device sends user data to the second (first) device at a transmission rate whereby this transmission rate exceeds a processing rate of the second (first) device.

According to a further embodiment of the invention, the transmission rate comparison can be achieved with the aid of two signals, a first and a second signal. If the first (second) device receives the first signal, it does not send any further data to the second (first) device until it receives the second signal or until a time interval has elapsed that is defined by the first signal. The first (second) device can then send the first signal to the second (first) device if the first (second) device registers that a specific capacity of the memory elements of the first (second) device has been exceeded beyond a predetermined threshold value. In this, the memory elements store data that have been sent from the second (first) device but that could not yet be sent further or processed by the first (second) device. Another condition on the occurrence of which the first (second) device sends the first signal to the second (first) device may also be present if the memory elements of the first (second) device no longer offer any space to store more than a maximum size data stream from the second (first) device during a specific time interval. In this, the time interval is determined by the time that elapses between a first and a second time-point. In this, the first (second) device decides to send the first signal to the second (first) device at the first time-point, whereby the second time-point is present if the first (second) device no longer receives any data from the second (first) device, as the first (second) device has sent the first signal to the second (first) device. In other words, the first (second) device then sends the first signal to the second (first) device if the first (second) device registers that it cannot accept any more data from the second (first) device in its memory elements than those that are still being sent to it from the second (first) device until the data stream from the second (first) device is interrupted due to the first signal being received.

Conversely, the second signal is then sent from the first (second) device to the second (first) device if the memory elements of the first (second) device again have sufficient space, e.g. because the first (second) device has processed or passed on the data present in the memory elements.

With this procedure according to the embodiment of the invention it is almost impossible for there to be a loss of data, in that the first (second) device sends data to the second (first) device which the second (first) device must not accept in its memory elements and must therefore reject.

According to a further embodiment of the invention, the first (second) device can also send the first signal or the second signal to the second (first) device in a time interval between receiving the first signal and before receiving the second signal. Only the sending of other data is forbidden in this time interval. Furthermore, after evaluating this signal, the first and/or the second signal may be immediately rejected by the first (second) device.

This ensures that for its part the first (second) device can interrupt or re-establish the data stream from the second (first) device also in a situation in which because it is receiving the first signal the first (second) device can send no more data to the second (first) device, in that it is sending the first or the second signal to the second (first) device. By rejecting the first or the second signal after an evaluation it is furthermore ensured that the first or second signal does not use up any further resources, e.g. the memory elements, of the first (second) device.

According to a further embodiment of the invention, both the first and also the second signal can be produced through a PMA-specific transmission. PMA (Physical Medium Attachment) is understood to be a physical media access control with which a functional interface to the transmission medium, i.e. to the data transmission by means of DSL technology, is provided. In particular, the first and second signal can be produced by a frame bit of a frame used for the transmitting of data or with the aid of a specific channel for the transmitting of data by means of DSL technology. A further possibility is that the first or second signal is produced by a specific Ethernet frame; for example, the first signal can be produced by a STOP-Ethernet frame or a PAUSE-frame and the second signal can be produced by a GO-Ethernet frame or a PAUSE-frame.

According to a further embodiment of the invention, the first and also the second signal may however also be produced by, in each case, a specific tone, i.e. a tone of a specific frequency.

This offers the advantage that both the first and-also the second signal can be generated and registered quickly, since neither encoding nor decoding are necessary to generate or register the signal.

The DSL technology chosen for transmitting data may be one of the following technologies:

ADSL technology

ADSL2 technology

ADSL2+ technology

VDSL technology

VDSL2 technology

SHDSL technology

According to a further embodiment of the present invention a device is also provided whereby this device comprises a first and a second unit. These two units communicate with each other via a medium independent interface (MII). The first unit is connected to a further device via a transmission line, whereby this further device is designed for transmitting data by means of DSL technology. The first unit is similarly configured such that it transmits and receives data by means of DSL technology over the transmission line. Furthermore, the second unit is configured in order to send data to the first unit and receive data from the first unit.

According to a further embodiment of the invention, the first unit operates in particular at the first layer of the OSI layer model and the second unit operates at the second layer of the OSI layer model.

The present invention is suited preferably for use in communication networks in which transmission to the end-node is carried out with DSL technology. Naturally, the invention is however not limited to this preferred area of application, but can for example also be used for two remote devices that exchange data using DSL technology.

Hereinafter, embodiments of the invention will be described in more detail with reference to the drawings.

In the sole FIGURE a first device 1 and a second device 2 are shown, which communicate via connections 13, 14 by means of DSL technology with Ethernet data (Ethernet protocol). The second device 2 is a communication device that has an interface 11 to the internet, which can therefore be regarded as being a type of intermediate node within a communication network. On the other hand, the first device 1 is a communication device that is preferably with a participant and has an interface 12 to which for example a PC (not shown) can be connected. The first device 1 belongs to a customer premises equipment (CPE), while the second device 2 belongs to a central office termination (COT). The first device 1 comprises a first unit 3, which has a first memory element 7 and a second memory element 8, and a second unit 4. In the same way, the second device 2 comprises a first unit 6, which has a first memory element 9 and a second memory element 10, and a second unit 9. Both within the first device 1 and also within the second device 2, the units 3, 4, 5, 6 communicate via a medium independent interface (MII) via Ethernet data (Ethernet protocol). Both first units 3, 6 are able to send and receive data with the first layer of the OSI layer model, the so-called physical layer (PHY), on the so-called first mile by means of Ethernet and DSL technology, while both second units 4, 5 have a medium-specific control (MAC). To simplify further description, below, the first unit 3 of the first device 1 is called EFM PHY (CPE) and the second unit 4 of the first device 1 is called MAC (CPE) and the first unit 6 of the second device 2 is called EFM PHY (COT) and the second unit 5 of the second device 2 is called MAC (COT).

It is explained below how data is communicated. Via the interface 11 to the internet the MAC (COT) 5 receives data that it forwards to the EFM PHY (COT) 6. The EFM PHY (COT) 6 collects this data in its first memory element 9, which is assigned to a connection 18 between the MAC (COT) 5 and the EFM PHY (COT) 6, before it forwards it further via connection 13 to the EFM PHY (CPE) 3. With this, a transmission rate comparison is obtained at the connection 18 between the MAC (COT) and the EFM PHY (COT), and also at a connection 15 between the MAC (CPE) and the EFM PHY (CPE), as it is defined in the standard IEEE 802.3-2004. The EFM PHY (COT) 6 then sends a CRS signal 19 to the MAC (COT) 5 if the EFM PHY (COT) registers that there is a risk of its first memory element 9 becoming full. This guarantees that the MAC (COT) 5 sends no more data to the EFM PHY (COT) 6 than the EFM PHY (COT) 6 can pass on via the connection 13 to the EFM PHY (CPE) 3. The same applies for the connection between MAC (CPE) 4 and EFM PHY (CPE) 3, namely, the EFM PHY (CPE) 3 sends a CRS signal 16 to the MAC (CPE) 4 if a specific capacity of the second memory element 8 of the EFM PHY (CPE) 3 is reached.

Below it is assumed that the MAC (COT) 5 sends data to the EFM PHY (COT) 6 via the MII at a transmission rate of 100 Mbit/s (less an inter-packet gap, tx_rx_simultaneously=1). The inter-packet gap is a time delay between successive data packets for protocol reasons and tx_rx_simultaneously=1 shows that between MAC (COT) 5 and EFM PHY (COT) 6 the system is interacting simultaneously, i.e. data are being sent and received at the same time. For its part the EFM PHY (COT) 6 sends the data received by means of DSL technology and at the data rate used with DSL technology, which is greater than 100 Mbit/s, via the connection 13 to the EFM PHY (CPE) 3. In the transmitting of data from the MAC (COT) 5 to the EFM PHY (COT) 6 no loss of data can occur, as explained above. To transmit data between the EFM PHY (CPE) 3 and the MAC (CPE) 4 via a connection 17 an effective data rate of 50 Mbit/s is used (less an inter-packet gap, tx_rx_simultaneously=0), whereby tx_rx_simultaneously=0 shows that data cannot be sent in both directions at the same time between EFM PHY (CPE) 3 and MAC (CPE) 4, which is why at 50 Mbit/s the data rate here is only half the data rate of 100 Mbit/s used between MAC (COT) 5 and EFM PHY (COT) 6. With this, the first memory element 7 of the EFM PHY (CPE) 3 slowly becomes full, since the EFM PHY (CPE) 3 receives more data from the EPM PHY (COT) 6 per unit of time than it can forward via the MII to the MAC (CPE) 4.

The invention takes effect here in that the EFM PHY (CPE) 3 notifies the EFM PHY (COT) 6 via a first signal sent via the connection 14 that the EFM PHY (COT) 6 should not send any more data to the EFM PHY (CPE) 3 until a specific time, which is defined by the first signal, has elapsed or until the EFM PHY (CPE) 3 sends the EFM PHY (COT) 6 a second signal.

With this, on the connection 13, 14 between the EFM PHY (COT) 6 and the EFM PHY (CPE) 3, which is also called line 13, 14, a transmission rate comparison is achieved which applies for both transmission directions. It is pointed out that such a transmission rate comparison on the line 13, 14 is not provided for in the standard IEEE 802.3-2004 (Ethernet standard).

Both signals can be transmitted by means of a PMA-specific transmission, for example via a specific channel (operational channel) or via a frame bit or by sound.

Below it is assumed that the first signal is produced by a STOP-frame and the second signal by a GO-frame, whereby the STOP-frame and the GO-frame are special Ethernet frames.

If the EFM PHY (CPE) 3 registers that there is a risk of its first memory element 7 becoming full, it sends the STOP-frame over the line 14 to the EFM PHY (COT). The EFM PHY (COT) 6 receives the STOP-frame, analyses the STOP-frame and interrupts the sending of data to the EFM PHY (CPE) 3. Furthermore, the EFM PHY (COT) 6 discards the STOP-frame, i.e. it does not store it in its second memory element 10 and neither does it forward it to the MAC (COT) 5. In this state, the EFM PHY (COT) can only send STOP and GO-frames over the line 13 to the EFM PHY (CPE). This is necessary as well, since as before the EFM PHY (CPE) 3 is sending data to the EFM PHY (COT) 6. If in this state in which it cannot send any data to the EFM PHY (CPE) 3 the EFM PHY (COT) 6 recognises that its second memory element 10 is also full, it can likewise send the STOP-frame over the line 13 to the EFM PHY (CPE) 3 in order to interrupt the further sending of data via the EFM PHY (CPE) 3 over the line 14.

After a time the EFM PHY (CPE) 3 has clearly emptied its first memory element 7, in that it has sent data stored in it via the MII via a connection 16 to the MAC (CPE) 4. As soon as the free memory space in the first memory element 7 has fallen below a specific threshold value, the EFM PHY (CPE) 3 sends the GO-frame over the line 14 to the EFM PHY (COT) 6, whereupon it continues to transmit data over the line 13 to the EFM PHY (CPE) 3.

With this method described it is ensured that when transmitting data over the line 13, 14 by means of DSL technology in both transmission directions no loss of data occurs, since with regard to these directions there is a back pressure if the sending EFM PHY 3 sends 6 at a higher data rate than the received EFM PHY 6 can process 3.

Instead of the STOP-frame, the PAUSE-frame, which likewise is a special Ethernet frame, can also be used for the first signal. The use of the PAUSE-frame is explained below on the basis of an example.

If for example the EFM PHY (COT) 6 recognises that its second memory element 10, which stores the data coming in over the line 14, is more than a specific per cent full, as the EFM PHY (COT) 6 is receiving more data over the line 14 that it can forward via the connection 20, the EFM PHY (COT) 6 sends the PAUSE-frame over the line 13 to the EFM PHY (CPE) 3. The EFM PHY (CPE) 3 analyses the PAUSE-frame, discards the PAUSE-frame and interrupts the sending of data to the EFM PHY (COT) 6 for a time, which is given within the PAUSE-frame. Of course, in this state the EFM PHY (CPE) 3 is still permitted to send even the PAUSE-frame over the line 14 to the EFM PHY (COT) 6, in order for its part to prevent overflowing of its first memory element 7, which stores or buffers the data coming in from the line 13. If the EFM PHY (COT) 6 recognises that its second memory element 10 offers sufficient space again, but the time set in the PAUSE-frame sent to the EFM PHY (CPE) 3 has not elapsed yet, the EFM PHY (COT) 6 can re-start the data stream from the EFM PHY (CPE) 3 by the EFM PHY (COT) 6 sending a corresponding PAUSE-frame to the EFM PHY (CPE) 3.

1. A method for transmitting data, whereby data are transmitted between a first device and a second device by means of DSL technology, wherein
when transmitting data with DSL technology transmission rates are compared.

2. The method according to claim 1,
wherein both the first device and also the second device each comprise a unit which operates at the first layer of the OSI layer model whereby the transmitting of data takes place between these two units with DSL technology.

3. The method according to claim 1,
wherein the first device is disposed in an end-node of a communication network and the second device is disposed in an intermediate node of the communication network.

4. The method according to claim 1,
wherein from the first device a first signal is sent to the second device, on receipt of which the second device does not send any more data to the first device until a time predetermined by the first signal has elapsed or until a second signal is received, if a condition is satisfied that is selected from a group comprising
(i) memory elements of the first device that store data from the second device that could not yet be sent further from the first device are filled beyond a predetermined first threshold value, and
(ii) the memory elements of the first device do not offer any more space to store more than a maximum size data stream from the second device which streams for a time interval whereby the time interval is the time that elapses from a time-point at which the first device decides to send the first signal to the second device until a time-point at which because of the first signal that has been sent no more data from the second device are received by the first device.

5. The method according to claim 4,
wherein from the first device the second signal is sent to the second device, on receipt of which the second device sends data which are to be sent to the first device to the first device, if a condition is satisfied that is selected from a group comprising
(i) the memory elements of the first device are filled below a predetermined second threshold value,
and
(ii) the memory elements of the first device offer more than sufficient space to store the maximum size data stream from the second device that streams for the time interval.

6. The method according to claim 4,
wherein from the second device the first signal is sent to the first device, on receipt of which the first device does not send any more data to the second device until the time predetermined by the first signal has elapsed or until the second signal is received, if a condition is satisfied that is selected from a group comprising
(i) memory elements of the second device that store data from the first device that could not yet be sent further from the second device are filled beyond a predetermined second threshold value, and
(ii) the memory elements of the second device do not offer any more space to store more than a maximum size data stream from the first device which streams for a further time interval whereby the further time interval is the time that elapses from a time-point at which the second device decides to send the first signal to the first device until a time-point at which because of the first signal that has been sent no more data from the first device are received by the second device.

7. The method according to claim 6,
wherein from the second device the second signal is sent to the first device, on receipt of which the first device sends data which is to be sent to the second device to the second device, if a condition is satisfied that is selected from a group comprising
(i) the memory elements of the second device are filled below a predetermined fourth threshold value,
and
(ii) the memory elements of the second device offer more than sufficient space to store the maximum size data stream from the first device that streams for the time interval.

8. The method according to claim 4,
wherein when checking whether the memory elements offer sufficient space to accept the maximum size data stream, a predetermined quantity of data is taken into account as a safety buffer.

9. The method according to claim 4,
wherein after receiving the first signal and before receiving the second signal, the second device sends only the first signal or the second signal to the first device.

10. The method according to claim 4,
wherein, after evaluation, the first signal and/or the second signal is discarded immediately.

11. The method according to claim 4,
wherein the first and/or second signal is/are produced by a PMA-specific transmission.

12. The method according to claim 11,
wherein the first and/or second signal is/are produced by a specific tone.

13. The method according to claim 11,
wherein the first and/or second signal is/are produced by a frame bit or with the aid of a specific channel of the data transmission by means of DSL technology.

14. The method according to claim 4,
wherein the first and/or second signal is/are produced by a specific frame

15. The method according to claim 14,
wherein the specific frame is an Ethernet frame.

16. The method according to claim 15,
wherein the first signal is produced by a STOP-Ethernet frame and/or the second signal is/are produced by a GO-Ethernet frame, whereby after receiving the STOP-Ethernet frame, a receiver of the STOP-Ethernet frame does not send any more user data to a sender of the STOP-Ethernet frame until the receiver receives the GO-Ethernet frame from the sender.

17. The method according to claim 15,
wherein the first signal and/or second signal is produced by a PAUSE-Ethernet frame.

18. The method according to claim 1,
wherein the DSL technology is selected from ADSL technology, ADSL2 technology, ADSL2+ technology, VDSL technology, VDSL2 technology or SHDSL technology.

19-25. (canceled)

26. A method for transmitting data, whereby data are transmitted between a first device and a second device by means of DSL technology,
wherein, when transmitting data with DSL technology, transmission rates are compared, wherein both the first device and also the second device each comprise a unit which operates at the first layer of the OSI layer model whereby the transmitting of data takes place between these two unites with DSL technology,
wherein the first device is disposed in an end-node of a communication network and the second device is disposed in an intermediate noted of the communication network.

27. The method according to claim 19,
wherein from the first device a first signal is sent to the second device, on receipt of which the second device does not send any more data to the first device until a time predetermined by the first signal has elapsed or until a second signal is received, if a condition is satisfied that is selected from a group comprising
(i) memory elements of the first device that store data from the second device that could not yet be sent further from the first device are filled beyond a predetermined first threshold value, and
(ii) the memory elements of the first device do not offer any more space to store more than a maximum size data stream from the second device which streams for a time interval whereby the time interval is the time that elapses from a time-point at which the first device decides to send the first signal to the second device until a time-point at which because of the first signal that has been sent no more data from the second device are received by the first device.

28. The method according to claim 20,
wherein from the first device the second signal is sent to the second device, on receipt of which the second device sends data which are to be sent to the first device to the first device, if a condition is satisfied that is selected from a group comprising
(i) the memory elements of the first device are filled below a predetermined second threshold value, and
(ii) the memory elements of the first device offer more than sufficient space to store the maximum size data stream from the second device that streams for the time interval.

29. The method according to claim 20,
wherein from the second device the first signal is sent to the first device, on receipt of which the first device does not send any more data to the second device until the time predetermined by the first signal has elapsed or until the second signal is received, if a condition is satisfied that is selected from a group comprising
(i) memory elements of the second device that store data from the first device that could not yet be sent further from the second device are filled beyond a predetermined second threshold value, and
(ii) the memory elements of the second device do not offer any more space to store more than a maximum size data stream from the first device which streams for a further time interval whereby the further time interval is the time that elapses from a time-point at which the second device decides to send the first signal to the first device until a time-point at which because of the first signal that has been sent no more data from the first device are received by the second device.

30. The method according to claim 22,
wherein from the second device the second signal is sent to the first device, on receipt of which the first device sends data which is to be sent to the second device to the second device, if a condition is satisfied that is selected from a group comprising
(i) the memory elements of the second device are filled below a predetermined fourth threshold value,
and
(ii) the memory elements of the second device offer more than sufficient space to store the maximum size data stream from the first device that streams for the time interval.

31. A device for transmitting data that is configured such that the device can send and receive data using DSL technology,
wherein the device is configured to compare transmission rates when transmitting data in accordance with DSL technology.

32. The device according to claim 24,
wherein the device comprises a first unit and a second unit, which are connected via a media-independent interface, whereby the first unit is connected via a transmission line to a further device, which is configured to transmit data in accordance with DSL technology, whereby the first unit is configured such that the first unit transmits and receives data over the transmission line using DSL technology, whereby the second unit is configured such that the second unit sends data to the first unit and receives data from the first unit.

33. The device according to claim 25,
wherein the first unit comprises memory elements,
the first unit is configured such that the first unit stores data in the memory elements that the first unit receives over the transmission line but has not yet sent to the second unit, and wherein the first unit sends a first signal over the transmission line if the first unit registers that a specific capacity of the memory elements has been filled beyond a predetermined first threshold value, or if the first unit registers that the memory elements no longer offer space to store more than a maximum size data stream from the transmission line which streams for a time interval, whereby the time interval is the time that elapses from a time-point at which the first unit decides to send the first signal until a time-point at which due to the first signal that has been sent no more data is received from the first unit over the transmission line.

34. The device according to claim 26,
wherein the first unit is configured such that the first unit sends a second signal over the transmission line if the first unit registers that the memory elements are filled below a predetermined second threshold value, or if the first unit registers that the memory elements offer more than sufficient space to store the maximum size data stream from the transmission line that streams for the time interval.

35. The device according to claim 25,
wherein the first unit is configured such that the first unit, when the first unit receives the first signal, does not send any more data over the transmission line, except for the first and second signal, until a time predetermined by the first signal has elapsed or until the first unit receives the second signal.

36. The device according to claim 25,
wherein the first unit is configured such that the first unit operates at the first layer of the OSI layer model and in that the second unit is configured such that the second unit operates at the second layer of the OSI layer model.
